(19) United States
(12) Patent Application Publication
(10) Pub. No.: US 2025/0222291 A1
(43) Pub. Date: Jul. 10, 2025

(54) DEVICE AND METHOD FOR DETECTING A FOREST FIRE

(71) Applicant: DRYAD NETWORKS GMBH, Eberswalde (DE)

(72) Inventors: Carsten BRINKSCHULTE, Berlin (DE); Marco BÖNIG, Dortmund (DE)

(73) Assignee: DRYAD NETWORKS GMBH, Eberswalde (DE)

(21) Appl. No.: 18/849,511

(22) PCT Filed: Mar. 21, 2023
(86) PCT No.: PCT/EP2023/057230

§ 371 Date: Sep. 22, 2024

(30) Foreign Application Priority Data
Mar. 21, 2022 (DE) 10 2022 106 521.9
Dec. 13, 2022 (DE) 10 2022 133 171.7

(51) Int. Cl. A62C 3/02; G05D 105/55; G05D 105/80; G05D 109/20

(52) U.S. Cl. CPC A62C 3/0271; G05D 2105/55; G05D 2105/80; G05D 2109/20

(57) ABSTRACT

The invention relates to a method for detecting and/or locating a forest fire, comprising the following method steps: receiving information, generating a control command, sending the control command and/or information and carrying out a forest fire detection process. The invention further relates to a forest fire detection system comprising a network device, a server unit, a gateway, a first terminal, the first terminal having a sensor unit, and a second terminal, the second terminal having a forest fire detection element.

The invention relates to a method for detecting and/or locating a forest fire with the steps of receiving information, generating a control command, sending the control command and/or information and carrying out a forest fire detection process. The invention further relates to a forest fire detection system comprising a network device, a server unit, a gateway, a first terminal, wherein the first terminal has a sensor unit, and a second terminal, wherein the second terminal has a forest fire detection element.

### PRIOR ART

Systems for detecting and locating forest fires are known. For this purpose, the area to be monitored is monitored using optical sensors that can detect the columns of smoke created by a forest fire. These sensors are, for example, rotating cameras, but they have the disadvantage that they are less effective at night and are susceptible to false detections, e.g. in the case of dust clouds resulting from agricultural activities. In addition, optical systems can usually only detect the forest fire when the forest fire is already advanced and the smoke columns become visible over greater distances. Monitoring using an IR camera installed in a satellite from a high orbit has the disadvantage that the resolution of the cameras over large distances prevents detection of forest fires in the early stages. A satellite is also expensive to purchase and maintain, in particular at satellite launch. Monitoring by low orbit satellites has the disadvantage that the satellites are not geostationary, so that require a certain amount of time to complete one orbit, during which the area is not monitored. Close-meshed monitoring requires a large number of satellites, the launch of which is also costly. Satellite monitoring also involves high carbon dioxide emissions during their launch.

It is thus the object of the present invention to provide a method for detecting a forest fire that works reliably and automatically, can be expanded as desired and is inexpensive to install and maintain. It is also the object of the present invention to provide a system for detecting a forest fire that works reliably and automatically, can be expanded as desired and is inexpensive to install and maintain. It is also an object of the present invention to provide a device for detecting a forest fire that works reliably and automatically, can be expanded as desired and is inexpensive to install and maintain. It is also an object of the present invention to provide an autonomous unit for detecting a forest fire that works reliably and automatically, can be expanded as desired and is inexpensive to install and maintain. It is also an object of the present invention to provide a station for detecting a forest fire that works reliably and automatically, can be expanded as desired and is inexpensive to install and maintain.

The object is achieved with the method according to the invention for detecting and/or locating a forest fire with a forest fire detection station according to claim 1. Advantageous embodiments of the invention are provided in the dependent claims.

The method according to the invention for detecting and/or extinguishing a forest fire with a forest fire detection station has four steps: In the first step, information is received. The information includes, for example, the detection of a forest fire, its position and, if applicable, its speed and direction of propagation. In the second step, a control command is generated. The control command contains the received information and commands for detecting a forest fire. In the third process step, a control command and/or information is sent. In the fourth step, a forest fire detection process is carried out.

In a further development of the invention, the reception of information takes place on a server unit. The server unit is part of a network for detecting and reporting forest fires. The network is preferably a LoRaWAN network, which has a star-shaped architecture in which message packets are exchanged between the first forest fire detection sensors and a central server unit by means of gateways.

In a further embodiment of the invention, the information is sent from a terminal. The forest fire detection sensor is part of a terminal and is arranged in it. The terminals are connected to gateways via a single-hop connection.

In a further embodiment of the invention, the information is sent via a network. The network is preferably a LoRaWAN network, which has a star-shaped architecture in which message packets are exchanged between the terminals and a central server unit by means of gateways.

In a further embodiment of the invention, the information contains the result of an analysis. The analysis is, for example, a gas analysis and a recording of the temperature of the gases that are produced during a forest fire. In addition to heavy smoke, a forest fire produces a plurality of gases, particularly carbon dioxide and carbon monoxide. The type and concentration of these gases are characteristic of a forest fire and can be detected using suitable sensors.

In a further embodiment of the invention, the analysis is carried out using measurement data from a sensor. The sensor is, for example, a sensor array for gas analysis, for recording the temperature of the gases and for recording the prevailing wind direction and speed.

In a further aspect of the invention, the measurement data are recorded on the terminal. The sensor is part of a terminal and is arranged in it.

In a further development of the invention, the analysis is carried out on the terminal or the server unit. A software program is stored in memory on the server unit, which software can be used to perform the analysis automatically.

In a further embodiment of the invention, the control command or information for generating a control command is generated from the information. The control command initiates the detection of a forest fire.

In a further embodiment of the invention, the control command or the information for generating a control command is sent. The control command, preferably generated on the server unit, is sent to the forest fire detection device via IP connection and cable.

In a further embodiment of the invention, the control command or the information for generating a control command is sent from the server unit to the forest fire detection device. The control command, preferably generated on the server unit, is sent to the forest fire detection device via IP connection and cable, and the process for detecting a detected forest fire is initiated.

In a further development of the invention, sending is carried out via a network. The network is preferably a LoRaWAN network which has a star-shaped architecture in which message packets are exchanged between the first forest fire detection sensors and a central server unit by means of gateways.

In a further embodiment of the invention, the forest fire detection process comprises a first positioning of a forest fire detection unit. The forest fire detection unit is positioned near the fire source in such a way that the forest fire detection unit detects the fire source by means of a suitable sensor, preferably an infrared camera.

In a further embodiment of the invention, the forest fire detection process includes locating the fire source. The forest fire detection unit is positioned near the fire source in such a way that the forest fire detection unit detects the fire source by means of a suitable sensor, preferably an infrared camera.

In a further embodiment of the invention, the forest fire detection process comprises the ejection of a forest fire detection agent. The forest fire detection agent is dropped by the forest fire detection unit onto or within a radius around the fire source.

The object is also achieved with the forest fire detection system according to the invention. Advantageous embodiments of the invention are also set out in the dependent claims.

The forest fire detection system according to the invention comprises a network device, a server unit and a gateway. The forest fire detection system features a mesh gateway network that uses LoRaWAN network technology. The LoRaWAN network has a star-shaped architecture in which message packets are exchanged between the sensors and a central Internet network server by means of gateways.

The forest fire detection system has a plurality of sensors, which are connected to gateways via a single-hop connection. The gateways are usually frontend gateways. The front-end gateways are connected to each other and partly to border gateways. A border gateway can also be combined with a front-end gateway to form a mesh gateway device in one apparatus. The border gateways are connected to the Internet network server NS, either via a wired connection or via a wireless connection by means of the Internet protocol.

The forest fire detection system according to the invention also has a first terminal, wherein the first terminal has a sensor unit.

The forest fire detection system according to the invention additionally has a second terminal, wherein the second terminal has a forest fire detection element.

In a further development of the invention, the network is a LoRaWAN network with a server, gateway, a first terminal, and a second terminal different from the first terminal. The second terminal is preferably a forest fire detection unit having a sensor for detecting a forest fire and a device for detecting a forest fire.

In a further embodiment of the invention, the first terminal has a sensor unit and/or the second terminal has a forest fire detection unit. The second terminal is preferably a forest fire detection unit having a sensor for detecting a forest fire and a device for detecting a forest fire.

In a further embodiment of the invention, the first terminal is arranged in a fixed location, e.g. on a tree in the forest to be monitored.

In a further embodiment of the invention, the first terminal has a sensor for forest fire detection, a communication device, an energy storage and/or an energy conversion device. The first terminal can thus be operated independently and can be connected to the central network server via the communication device. The sensor is a sensor for gas analysis, for recording the temperature of the gases and for recording the prevailing wind direction and speed.

In a further embodiment of the invention, the second terminal is mobile, e.g. a flight-capable drone.

In a further embodiment of the invention, the second terminal has a sensor for forest fire detection, a navigation device, a drive and/or an energy storage. The navigation sensors comprise one or a plurality of cameras and/or time-of-flight based sensors that detect obstacles during the movement of the second terminal. The second terminal is therefore able to circumvent these obstacles.

In a further development of the invention, the sensor of the first terminal is different from the sensor of the second terminal. The first detection of the forest fire using the first terminal is preferably carried out by detecting and analyzing the gases (smoke) produced by a forest fire and their temperature. The second detection uses a different method than the first detection, e.g. an image acquisition method or a method for detecting particles. Using an image capture process, the fire source can be detected more precisely; in particular, the extent of the fire source and its direction of propagation can be recorded more precisely. The imaging process preferably produces a thermal image of the fire source.

In a further embodiment of the invention, the network has a central server. An executable program that controls the detection of a forest fire is stored in memory on the central server.

In a further embodiment of the invention, the network has a plurality of gateways, wherein the gateways are mesh gateways and/or border gateways. Message packets can be exchanged between the sensors and a central Internet network server NS by means of gateways. The mesh-gateways are connected to each other and partly to border gateways. The border gateways are connected to the Internet network server, either via a wired connection or via a wireless connection by means of the Internet protocol.

The object is also achieved by the method for detecting a forest fire. Advantageous embodiments of the invention are also set out in the dependent claims.

The method according to the invention for detecting a forest fire has six steps: In the first step, a first detection of a fire source takes place by means of a first forest fire detection sensor. The first forest fire detection sensor can be, for example, an optical sensor, gas sensor, particle sensor and/or temperature sensor.

In the second step, a first locating of the fire source initially takes place. In the simplest case, locating is done via the position of the first forest fire detection sensor, which performs the first detection. To do this, the position of the first forest fire detection sensor must be known. The position determination can be done, for example, when installing the first forest fire detection sensor. The first forest fire detection sensor can, for example, be arranged on a tree in the forest to be monitored and the position of the first forest fire detection sensor can be determined once using a navigation satellite system, e.g. GNSS (global navigation satellite system). For this purpose, a commercially available GPS system or a smartphone can be used.

The third step involves positioning a second forest fire detection sensor. For this purpose, the second forest fire detection sensor is preferably designed to be movable and is positioned at such a distance from the fire source that the second forest fire detection sensor carries out a second detection of a fire source in the fourth method step. The second forest fire detection sensor can also be, like the first forest fire detection sensor, an optical sensor, gas sensor, particle sensor or temperature sensor, for example. In addition to detecting the fire source, further information about the fire source can be determined using the second forest fire detection sensor, e.g. the extent, direction of propagation and speed of the fire source.

In the fifth step, a second locating of the fire source takes place. The locating of the fire source can occur, for example, by determining the position of the second forest fire detection sensor, wherein the position of the second forest fire detection sensor is also determined by means of a navigation satellite system, e.g. GNSS (global navigation satellite system). This second locating determines the location of the fire source with a lower error rate than the first locating of the fire source due to the spatial proximity of the second forest fire detection sensor to the fire source.

In the sixth step, the fire source is detected with a forest fire detection unit. Due to the more precise locating and the additional information about the fire source obtained by means of the second locating of the fire source, targeted and early detection and subsequent fighting of the fire source is possible.

For the purposes of this patent specification, forest fire detection means the detection of a forest fire and/or the detection of a fire source in the monitored area. In this document, the locating of forest fires includes not only the detection of a forest fire and/or fire source, but also the determination of the position of a forest fire and/or fire source.

For the purposes of this patent specification, fighting forest fires means detecting, locating, containing and/or extinguishing of a forest fire. Detecting includes recognizing a forest fire and/or recognizing a fire source in the monitored area. In this document, the locating of forest fires includes not only the detection of a forest fire and/or fire source, but also the determination of the position of a forest fire and/or fire source.

In a development of the invention, the first forest fire detection sensor is a stationary forest fire detection sensor. The first forest fire detection sensor can, for example, be arranged on a tree in a forest to be monitored.

In an advantageous embodiment of the invention, the first forest fire detection sensor is part of a terminal and/or gateway of a network. Preferably, the network is a LoRaWAN. The LoRaWAN network architecture is typically built in a star topology in which gateways act as a transparent bridge that forward messages between terminals and a central network server, terminals, and back-end. The gateways are connected to a corresponding network server via a standard IP connection, while the terminals use single-hop wireless communication (LoRa) to one or even more gateways. LoRaWAN networks implement a star-shaped architecture by means of gateway message packets between the terminals and the central network server. The gateways are connected to the network server via the standard Internet protocol, while the terminals communicate with the respective gateway by radio via LoRa (chirp frequency spread modulation) or FSK (frequency modulation).

In a further embodiment of the invention, the first forest fire detection sensor is part of a terminal and/or gateway, wherein the terminal and/or gateway is part of a network. A terminal has a first forest fire detection sensor, wherein the first forest fire detection sensor can be a sensor unit. The sensor unit of the first forest fire detection sensor has a plurality of sensors with which a forest fire can be detected. The network has a number of terminals that are distributed across the area to be monitored.

In a further embodiment of the invention, the first forest fire detection sensor detects the fire by detecting and analyzing smoke, gas, temperature, particles or other information. In addition to heavy smoke, a forest fire produces a plurality of gases, particularly carbon dioxide and carbon monoxide. In addition, the temperature of the gases is detected. In addition to the type and concentration of the gases produced in a forest fire, their temperature is an indicator of a forest fire. The type and concentration of these gases are characteristic of a forest fire and can be detected and analyzed using suitable sensors. The signals recorded by the sensor unit are analyzed with regard to the concentration of the composition of the gases. If a concentration of the gases is exceeded, a forest fire is detected. The type, composition, and temperature of the gases produced in a forest fire precisely indicate the occurrence of a forest fire. This makes it possible to capture a developing forest fire and to start its detection in a timely manner.

In a further embodiment of the invention, the first locating is determined by reading the position of the first forest fire detection sensor from a memory and/or by triangulating the position of the locating device and/or the forest fire detection sensor.

In the simplest case, locating is done via the position of the first forest fire detection sensor, which performs the first detection. To do this, the position of the first forest fire detection sensor must be known. The position determination can be done, for example, when installing the first forest fire detection sensor. The first forest fire detection sensor can, for example, be arranged on a tree in the forest to be monitored and the position of the first forest fire detection sensor can be determined once and stored using a navigation satellite system, such as GPS (global positioning system).

Another possibility is to locate a plurality of first forest fire detection sensors from the individual times at which each first forest fire detection sensor detects the forest fire. Forest fire signals detected by the forest fire detection sensors may each have different time stamps, meaning they may have been detected at different times. The difference in the detection of the signals is used to locate the forest fire.

In a further development of the invention, the first locating takes place taking into account the wind direction, the wind speed, the time of detection and/or the propagation time of the signals. The locating of a forest fire is carried out, for example, by means of a plurality of first forest fire detection sensors, in particular from the individual points in time at which each first forest fire detection sensor detects the forest fire. Forest fire signals detected by the forest fire detection sensors may each have different time stamps, meaning they may have been detected at different times. The difference in the detection of the signals is used to locate the forest fire. Due to the knowledge of the time of detection of the forest fire by the forest fire detection sensor, it is not only possible to determine the position of a forest fire more precisely, but also its speed of propagation. Wind direction and speed give fire-fighting forces an indication of the direction and speed of propagation of the forest fire. The detection of the fire source can therefore be used in a targeted and prioritized manner.

In a further advantageous embodiment of the invention, the positioning of the second forest fire detection sensor is carried out by positioning a second forest fire detection sensor closer to the located fire source than the first forest fire detection sensor at the time of the first detection. The second forest fire detection sensor is therefore positioned in such a way that it is closer to the fire source during the second detection and also the second locating of the fire source than the first forest fire detection sensor during the first detection and the first locating of the fire source. The second detection and the second locating of the fire source are therefore carried out with greater precision than the first detection and the first locating of the fire source.

In a further embodiment of the invention, the forest fire detection sensor that performed the second detection is a second forest fire detection sensor. The second forest fire detection sensor is used in addition to the first forest fire detection sensor to locate the forest fire. The first forest fire detection sensor performs a first detection and first locating of a forest fire, the second forest fire detection sensor performs a second detection and second locating of a forest fire.

In an advantageous development of the invention, the positioning of the second forest fire detection sensor takes place automatically. The positioning can be carried out, for example, by means of a vehicle in which the forest fire detection sensor is arranged or the forest fire detection sensor is such a vehicle. The forest fire detection sensor performs an automated process based on programming of the forest fire detection sensor.

In a further embodiment of the invention, the positioning of the second forest fire detection sensor takes place autonomously. The positioning is carried out in such a way that the second forest fire detection sensor is positioned independently without external influence. Obstacles, such as trees, are detected, analyzed and actively avoided.

In a particularly advantageous embodiment of the invention, the second forest fire detection sensor is part of a mobile forest fire detection unit. Due to this advantageous arrangement, it is possible to use the mobile forest fire detection unit to locate the forest fire detected by the second forest fire detection sensor immediately after detection and thus to give the fire-fighting forces precise instructions on how to fight and/or extinguish the forest fire. The propagation of the forest fire can thus be effectively reduced.

In a further embodiment of the invention, the second detection of a fire source is carried out with the second forest fire detection sensor. The second forest fire detection sensor is used in addition to the first forest fire detection sensor to locate the forest fire. The first forest fire detection sensor performs a first detection and first locating of a forest fire, the second forest fire detection sensor performs a second detection and second locating of a forest fire.

In a further aspect of the invention, the second detection of the fire source is carried out using a different method than the first detection. The first detection of the forest fire using the first forest fire detection sensor is preferably carried out by detecting and analyzing the gases (smoke) produced by a forest fire and their temperature. The second detection uses a different method than the first detection, e.g. an image capture method.

In a further development of the invention, the second detection uses an image capturing method. Using an image capture method, the fire source can be detected more precisely; in particular, the extent of the fire source and its direction of propagation can be recorded more precisely. The imaging process preferably produces a thermal image of the fire source.

In a further embodiment of the invention, the second location of the fire source is determined using the position of the second forest fire detection sensor. The second locating is carried out by means of the second forest fire detection sensor, which is positioned at a shorter distance from the fire source than the permanently installed first forest fire detection sensor at the time of the first locating. The second locating of the fire source is therefore carried out with greater precision than the first locating of the fire source.

In a further development of the invention, the second locating of the fire source is carried out using the measured values recorded by the second forest fire detection sensor. The second forest fire detection sensor uses suitable sensors, e.g. an infrared sensor, in combination with a navigation sensor to detect the position of the fire source with greater accuracy than the first forest fire detection sensor.

In a further embodiment of the invention, the second locating of the fire source is carried out with a control unit coupled to the second forest fire detection sensor. The control unit is designed as a microcontroller with control software. The control unit queries the second forest fire detection sensor, collects its measured values and determines the position of the fire source.

In a further aspect of the invention, the control unit is part of a forest fire detection unit. In particular the control unit is arranged in the forest fire detection unit.

In a further embodiment of the invention, the result of the second locating is sent to a network server. The control unit and/or a communication unit connected to the control unit sends the result of the second locating to the central network server of the network.

In a further development of the invention, in addition to the result of the second locating, further data are sent to the network server. In particular, data on the speed and direction of fire spread are sent.

In a further embodiment of the invention, the fire source is fought and/or extinguished using an extinguishing unit coupled to the second forest fire detection sensor. The second forest fire detection sensor advantageously has a coupled extinguishing unit in order to fight or extinguish the fire immediately and specifically after the second detecting and second locating of the fire source.

In a further development of the invention, the fire source is fought and/or extinguished by ejecting extinguishing agent. The extinguishing unit has an extinguishing agent reservoir filled with extinguishing agent. The extinguishing agent is ejected from the extinguishing agent reservoir onto the fire source.

In an advantageous embodiment of the invention, the ejection takes place several times. The extinguishing agent is ejected until either the fire source is extinguished or the extinguishing agent in the extinguishing unit is depleted. Infrasound, for example, can also be used as an extinguishing method.

In a further development of the invention, the extinguishing agent is distributed after ejection in directions different from the ejection direction. This ensures that the extinguishing agent is distributed in a radius around the fire source in such a way that the propagation of the fire is reduced.

In a further aspect of the invention, the extinguishing unit is part of a forest fire detection unit. In addition to the second forest fire detection sensor, the forest fire detection unit has the extinguishing unit in order to fight or extinguish the fire immediately and specifically after the second detection and second locating of the fire source.

In a further embodiment of the invention, the method steps of positioning a second forest fire detection sensor for detecting forest fires, second detecting of a fire source and second locating of the fire source are carried out several times. The positioning, second detecting and second locating using a forest fire detection unit are repeated in such a way that the fire source is located and detected with a low error rate. In addition, the propagation speed and direction are continuously updated. The fire source can therefore be detected more effectively.

In a further development of the invention, the method steps of positioning a second forest fire detection sensor for detecting forest fires, second detecting of a fire source, second locating of the fire source and fighting and/or extinguishing the fire source are carried out in parallel with several forest fire detection units. With multiple forest fire detection units, a fire source can be detected much more effectively than with just one forest fire detection unit.

The object is also achieved with the forest fire detection system according to the invention. Advantageous embodiments of the invention are provided in the dependent claims.

The forest fire detection system according to the invention has a first forest fire detection sensor for detecting forest fires. The first forest fire detection sensor is preferably arranged in a fixed location, e.g. on a tree in the forest to be monitored.

In addition, the forest fire detection system according to the invention has a position determination system which is suitable and intended to determine the position of the first forest fire detection sensor. The position determination system determines the position of the first forest fire detection sensor, e.g. when installing the first forest fire detection sensor. The first forest fire detection sensor can, for example, be arranged on a tree in the forest to be monitored and the position of the first forest fire detection sensor can be determined once using a navigation satellite system, such as GPS (global positioning system). For this purpose, a commercially available GPS system or a smartphone can be used. The position of a fire source is determined via the position of the first forest fire detection sensor.

The forest fire detection system according to the invention further comprises a second forest fire detection sensor and a locating system which is suitable and intended for determining the position of a fire source. The second forest fire detection sensor is used in addition to the first forest fire detection sensor for locating the forest fire. The first forest fire detection sensor performs a first detecting and first locating of a forest fire, the second forest fire detection sensor performs a second detecting and second locating of a forest fire. The locating system detects the source of a fire with a lower error rate than the first forest fire detection sensor.

The forest fire detection system also has a forest fire detection unit. In contrast to the first forest fire detection sensor, the forest fire detection unit is preferably mobile and suitable for carrying out a further detection of a fire source in addition to the first forest fire detection sensor.

In a further embodiment of the invention, the forest fire detection system comprises a network with a terminal, gateway, server and forest fire detection unit. The preferred network is a LoRaWAN. The LoRaWAN network architecture is typically built in a star topology in which gateways act as a transparent bridge that forward messages between terminals and a central network server, terminals, and back-end. The gateways are connected to a corresponding network server via a standard IP connection, while the terminals use single-hop wireless communication (LoRa) to one or more gateways. LoRaWAN networks implement a star-shaped architecture using gateway message packets between the terminals and the central network server. The gateways (also called concentrators or base stations) are connected to the network server via the standard Internet protocol, while the terminals communicate with the respective gateway by radio link via LoRa (chirp frequency spread modulation) or FSK (frequency modulation).

In a development of the invention, the first forest fire detection sensor is arranged in a fixed location. The first forest fire detection sensor is preferably arranged on a tree, for example, of the forest to be monitored.

In a further embodiment of the invention, the first forest fire detection sensor is part of a terminal and/or gateway. A terminal and/or gateway has a first forest fire detection sensor, wherein the first forest fire detection sensor can be a sensor unit. The sensor unit of the first forest fire detection sensor has a plurality of sensors with which a forest fire can be detected. The network has a plurality of terminals and/or gateways that are distributed across the area to be monitored.

In an advantageous embodiment of the invention, the weather data can be recorded or retrieved using the forest fire detection system. The weather data includes, for example, wind speed and direction. Based on weather data, the direction and speed of a fire's propagation can be predicted.

In a further embodiment of the invention, the position of a fire source can be determined by the control of the forest fire detection system. The control has a memory in which a program is stored that can be executed by the control unit, which program determines the position of a fire source.

In a further embodiment of the invention, the position determination system of the forest fire detection system has stored the positions of stationary elements. Stationary elements of the forest fire detection system are, for example, the first forest fire detection sensors, which are arranged in terminals and gateways. The position of a terminal is stored permanently on the network server, for example.

In a development of the invention, the position determination system has determined the positions of stationary elements. Stationary elements of the forest fire detection system are for example the first forest fire detection sensors, which are arranged in terminals and gateways.

A navigation satellite system, for example, is used to determine the position. The determined position of a first forest fire detection sensor is also permanently stored on the network server, for example. Alternatively or additionally, the position determination of a first forest fire detection sensor can be determined and stored continuously or at intervals using the navigation satellite system.

In a further embodiment of the invention, the second forest fire detection sensor is movable. The second locating of a fire source is carried out by means of the second forest fire detection sensor, which is positioned at a shorter distance from the fire source than the permanently installed first forest fire detection sensor at the time of the first locating. The second locating of the fire source is therefore carried out with greater precision than the first locating of the fire source.

In an advantageous embodiment of the invention, the second forest fire detection sensor is part of the forest fire detection unit. After the first detection and locating of a fire source by the first forest fire detection sensor, the fire source is detected by the second forest fire detection sensor.

In a further embodiment of the invention, the second forest fire detection sensor comprises an image-capturing forest fire detection sensor. Using an image capture process, the fire source can be detected more precisely; in particular, the extent of the fire source and its direction of propagation can be recorded more precisely. The image-capturing forest fire detection sensor preferably creates a thermal image of the fire source.

In a further embodiment of the invention, the locating system is suitable and intended to determine the position of the fire source. The locating system is arranged in the second forest fire detection sensor, which is positioned at a shorter distance from the fire source than the first forest fire detection sensor. Locating the fire source is therefore more precise than the initial locating of the fire source using a first forest fire detection sensor.

In a further development of the invention, the locating system is suitable and intended to determine the position of the fire source relative to the position of the locating system. The locating system is arranged in the second forest fire detection sensor, which is movable. The position of the fire source is determined relative to the position of the second forest fire detection sensor and has a low error rate.

In a further embodiment of the invention, the locating system uses a triangulation method for position determination, in which the distance, for example, to stationary elements of the forest fire detection system, such as the first forest fire detection sensors and/or the gateways, is determined.

In a further embodiment of the invention, the first control is part of the central server of a network. The first control is stationary and is, for example, a microcomputer and has memory and microprocessor as well as suitable software.

In a further embodiment of the invention, the second control is part of the forest fire detection unit. The second controller has a memory in which an executable is stored by the second controller that enables the operation of the forest fire detection unit.

In an advantageous embodiment of the invention, the forest fire detection unit is designed as a motorized vehicle. Preferably, the forest fire detection unit is capable of flying so that it can cover larger distances in a short time.

In a further development of the invention, the forest fire detection unit is a drone and/or a robot. The forest fire detection unit is preferably unmanned and enables automatic and/or autonomous detection of a fire source.

In a further embodiment of the invention, the forest fire detection unit comprises the second forest fire detection sensor, a drive unit, an energy unit, a navigation unit, a steering unit, a control unit and/or a communication unit and/or an extinguishing unit. The forest fire detection unit is preferably a flight-capable drone that automatically and/or autonomously detects a fire source.

In a further embodiment of the invention, the navigation unit has navigation sensors for detecting objects in the environment. The navigation sensors particularly detect obstacles that may occur during movement of the forest fire detection unit. The forest fire detection unit is therefore able to bypass these obstacles.

In a further development of the invention, the navigation sensors are cameras and/or sensors based on time of flight measurement. The navigation sensors comprise one or a plurality of cameras and/or time-of-flight based sensors that detect obstacles during the movement of the second terminal. The obstacles are detected, recognized and analyzed by the control unit arranged in the forest fire detection unit in such a way that the forest fire detection unit automatically avoids the obstacles during movement.

In a further embodiment of the invention, the sensors based on time-of-flight measurement are radar, ultrasonic and/or LIDAR sensors. The navigation sensors comprise one or a plurality of cameras and/or time-of-flight based sensors that detect obstacles during the movement of the second terminal. The obstacles are detected, recognized and analyzed by the control unit arranged in the forest fire detection unit in such a way that the forest fire detection unit automatically avoids the obstacles during movement.

In an advantageous embodiment of the invention, the forest fire detection system has a forest fire detection station. The forest fire detection station is a weatherproof station for housing the forest fire detection unit.

In a further development of the invention, the forest fire detection unit can be coupled to the forest fire detection station. The forest fire detection station is designed to be connected to, for example, an energy storage of the forest fire detection unit in order to supply the energy storage of the forest fire detection unit with electrical energy.

In a further embodiment of the invention, data, energy and/or extinguishing agents are exchangeable between the forest fire detection unit and the forest fire detection station.

The forest fire detection station is designed to be connected to, for example, an energy storage of the forest fire detection unit in order to supply the energy storage of the forest fire detection unit with electrical energy. In addition, the forest fire detection unit is filled with extinguishing agent. Alternatively, infrasound can be used to extinguish the fire.

The object is also achieved with the method according to the invention for detecting and/or locating a forest fire. Advantageous embodiments of the invention are set out in the dependent claims.

The method according to the invention for detecting and/or locating a forest fire has three method steps: In the first method step, a forest fire is detected in a forest area. For this purpose, a plurality of forest fire detection sensors are used, which are preferably arranged in a network.

In the second step, the fire source is located. Locating is carried out using a triangulation method, for example.

In the third process step, the fire source is automatically detected and/or located. For this purpose, a forest fire detection unit is used, which is preferably flight-capable and has appropriate sensors.

In a further development of the invention, the fire source is detected with a first forest fire detection sensor. The first forest fire detection sensor is arranged in a fixed location, e.g. on a tree in the forest area to be monitored.

In a further embodiment of the invention, the fire source is arranged from the data recorded by the first forest fire detection sensor, stored data, wind direction, wind speed and/or triangulation methods. The sensor units of the first forest fire detection sensor each detect a signal, the source of which is the gases generated by the forest fire, as well as the individual times of detection of the individual signals. Based on these detected signals and the recorded times of their detection, the position of the fire source is determined. Using wind direction and wind speed, position determination is possible with a low error rate.

In a further embodiment of the invention, an automatic forest fire detection and/or locating process is started after the fire source has been arranged. The automatic forest fire detection and/or locating process starts immediately after the fire source has been located, for example by using a flight-capable drone as a forest fire detection unit. Automatic detection and/or locating of a fire source can therefore begin immediately after a fire occurs. Once the forest fire has been located, forest fire fighting can optionally follow.

In a further development of the invention, the start of the forest fire detection and/or locating process includes the activation of a forest fire detection unit. The forest fire detection unit is usually in sleep mode to save energy. The forest fire detection unit is only activated when a signal is received to start a forest fire detection and/or locating process. The forest fire detection unit is optionally also used for forest fire fighting and in this case is equipped with an extinguishing agent.

In a further embodiment of the invention, the forest fire detection unit is re-positioned after the fire source has been located. The forest fire detection unit is preferably positioned near the fire source so that the fire source can be detected and/or located.

In a further embodiment of the invention, the positioning of the forest fire detection unit is based on the locating of the fire source. The forest fire detection unit is preferably positioned near the fire source so that the fire source can be detected and/or located. To do this, the position of a fire must be known as accurately as possible. The sensor units of the first forest fire detection sensor detect and locate the fire source and send the position data to the forest fire detection unit.

In a further development of the invention, a second locating of the fire source takes place before the automatic detection and/or locating of the fire source. The second locating is preferably carried out with a second forest fire detection sensor which is positioned near the fire source in such a way that the distance of the second forest fire detection sensor to the fire source is less than the distance of a first forest fire detection sensor at the time of the first detection of the forest fire.

In a further aspect of the invention, after the second locating of the fire source, a second positioning of the extinguishing unit takes place. Due to the second locating, the second positioning is carried out with a higher accuracy than the first positioning of the extinguishing unit.

In a further embodiment of the invention, the automatic detection and/or locating of the fire source is carried out by positioning the forest fire detection unit above the fire source and/or in its immediate vicinity. Due to the positioning, the automatic detection locating is carried out with a higher accuracy than the first positioning of the forest fire detection unit. For this purpose, the current position of the forest fire fighting unit is determined, for example, using GPS. Furthermore, a different sensor is used for the automatic detection and/or locating of the fire source by positioning the forest fire detection unit than with the first forest fire detection sensor. Preferably this is an IR camera.

The object is also achieved with the forest fire detection device according to the invention. Advantageous embodiments of the invention are set out in the dependent claims.

The forest fire detection device according to the invention comprises a fire sensor, a locating system and an automatic detection unit. A plurality of forest fire detection sensors, which are arranged in a network, for example, are designed to detect a forest fire and/or a fire source. The locating system is suitable and intended to determine the position of the fire source. Locating is carried out using a triangulation method, for example. The automatic detection unit has suitable sensors for detecting the fire source. The automatic detection unit is preferably part of a flight-capable drone that automatically detects a fire source.

In a further development of the invention, the fire sensor, the locating system and/or the automatic detection unit are arranged movably. The automatic detection unit is preferably part of a flight-capable drone that automatically detects and locates a forest fire and, optionally, also fights the fire source.

In a further embodiment of the invention, the fire sensor, the locating system and/or the automatic detection unit are part of a motorized vehicle. The automatic detection unit is preferably part of a flight-capable drone that automatically detects and locates a forest fire and, optionally, also fights the fire source.

In a further embodiment of the invention, the forest fire detection device comprises a forest fire detection unit and/or a forest fire detection station. The forest fire detection station is a weatherproof station for housing the forest fire detection unit. The forest fire detection unit includes the fire sensor and/or the locating system.

In a further embodiment of the invention, the forest fire detection unit comprises the second sensor, a drive unit, an energy unit, a navigation unit, a steering unit, a control unit and/or a communication unit. The forest fire detection unit preferably is a flight-capable drone that automatically detects and locates a fire source.

The object is also achieved with the method according to the invention for detecting and/or locating a forest fire. Advantageous embodiments of the invention are also set out in the dependent claims.

The method according to the invention for detecting and/or locating a forest fire has three method steps: In the first method step, information is received. The information includes, for example, the detection of a forest fire, its position and, if applicable, its speed and direction of propagation. In the second step, a forest fire detection unit is positioned autonomously based on the information received. In the third step, the fire source is detected and/or located with the forest fire detection unit, for example by using a flight-capable drone as a forest fire detection unit. Automatic detection and/or locating of a fire source can therefore begin immediately after a fire source is formed.

In a further development of the invention, the information includes position data, in particular the position of a forest fire and the position of a forest fire detection unit.

In a further embodiment of the invention, the information is sent for reception by a terminal and/or a central server and/or received by a forest fire detection device. The central server is, for example, a network server of a LoRaWAN mesh gateway network in which a plurality of forest fire detection sensors are arranged. The forest fire detection device has a forest fire detection unit.

In a further embodiment of the invention, the forest fire detection device comprises a forest fire detection station and/or a forest fire detection unit. The forest fire detection station is a weatherproof station for housing the forest fire detection unit.

In a further embodiment of the invention, the route is determined from own position data and destination position data. For example, a route is determined on the network server. The route includes the current position of the forest fire detection unit as part of the forest fire detection station as well as the position of the target area, in particular the position of the fire source.

In a further aspect of the invention, the forest fire detection unit is decoupled from a forest fire detection station. In standby mode, the forest fire detection unit is immovably coupled to the forest fire detection station.

In a development of the invention, the motor of the forest fire detection unit is started. The motor is preferably an electric motor that is supplied with electrical energy by means of an energy storage device (battery).

In a further embodiment of the invention, the forest fire detection unit is moved along a specific route by motor. The route includes the current position of the forest fire detection unit as part of the forest fire detection station as well as the position of the target area, in particular the position of the fire source.

In a further embodiment of the invention, the forest fire detection unit detects obstacles along a route. Obstacles include, for example, trees in the forest to be monitored that may be encountered during movement of the forest fire detection unit. The forest fire detection unit is therefore able to bypass these obstacles.

In a further development of the invention, the forest fire detection unit determines an alternative route to the target. The forest fire detection unit has a control unit that determines the bypass route based on the detected obstacles, the current position of the forest fire detection unit and the target position.

In a further embodiment of the invention, the forest fire detection unit will continue the motorized movement on the bypass route. Detection of obstacles, determination of an alternative route and motorized movement along the alternative route is continuously repeated and executed during the movement of the forest fire detection unit.

In a further embodiment of the invention, the forest fire detection unit detects the fire source after reaching the target area. Based on the first detecting and locating of the forest fire, a forest fire detection unit is positioned near the fire source in such a way that the forest fire detection unit detects the fire source by means of a suitable sensor, preferably an infrared camera.

In a further embodiment of the invention, the forest fire detection unit locates the fire source after reaching the target area. Based on the first detecting and locating of the forest fire, a forest fire detection unit is positioned near the fire source in such a way that the forest fire detection unit detects the fire source by means of a suitable sensor, preferably an infrared camera.

In an advantageous development of the invention, the forest fire detection unit extinguishes the fire source by ejecting extinguishing agents. Alternatively, infrasound can also be used as an extinguishing agent. The forest fire detection unit has an extinguishing agent reservoir. The extinguishing agent is, for example, water or a foam extinguishing agent.

In a further embodiment of the invention, a control unit of the forest fire detection unit generates and/or executes control commands for detecting a fire source, for locating a fire source, for moving the forest fire detection unit, for navigating the forest fire detection unit, for steering the forest fire detection unit and/or for ejecting extinguishing agents. The control unit is designed as a microcontroller and has memory and microprocessor with control software.

In a further embodiment of the invention, one or more of the preceding steps are carried out autonomously. The forest fire detection unit is preferably unmanned and designed as an autonomously controllable and flight-capable drone. Detection and extinguishing of a fire source can therefore take place within a short time window after the fire source has been detected.

The object is achieved with the method according to the invention for detecting and/or locating a forest fire with a forest fire detection station. Advantageous embodiments of the invention are also set out in the dependent claims.

The method according to the invention for detecting and/or locating a forest fire with a forest fire detection station has three steps: In the first step, information is received. The information includes, for example, the detection of a forest fire, its position and, if applicable, its speed and direction of propagation In the second step, a forest fire detection unit is decoupled from a forest fire detection station. The forest fire detection station is a weatherproof station for housing the forest fire detection unit. In standby mode, the forest fire detection unit is immovably coupled to the forest fire detection station. In the third step, the fire source is detected and/or located with the forest fire detection unit, for example by using a flight-capable drone as a forest fire detection unit. Detecting and/or locating of a fire source can therefore begin immediately after a detection of a fire source.

In a further embodiment of the invention, the information is forwarded from the forest fire detection unit to the forest fire detection station and/or from the forest fire detection station to the forest fire detection unit.

In a further development of the invention, the information includes position data, in particular the position of a forest fire and the position of a forest fire detection unit.

In a further embodiment of the invention, the position information includes the position of a detected forest fire or the position of the sensors detecting the forest fire. The sensors that detect forest fires are usually arranged in a fixed location, e.g. on a tree in the forest to be monitored. The position of the sensors detecting the forest fire is stored on a network server, for example, after it has been determined using GNSS or triangulation.

In a further embodiment of the invention, the forest fire detection process comprises positioning a forest fire detection unit. The forest fire detection unit is positioned near the fire source in such a way that the distance of the forest fire detection unit to the fire source is less than the distance of the sensors detecting the forest fire.

In a further embodiment of the invention, the forest fire detection process comprises the acquisition of sensor data from a sensor of the forest fire detection unit. The sensor is preferably an infrared camera that captures a thermal image of the fire source. In addition, sensors for gas analysis can be arranged in the forest fire detection unit.

In a development of the invention, the forest fire detection process comprises locating the position of the forest fire with the forest fire detection unit. The fire source is therefore more precisely located and can be fought more specifically.

In a further embodiment of the invention, the forest fire detection process comprises fighting the forest fire with an extinguishing agent. The forest fire detection unit contains extinguishing agents, e.g. water or a foam extinguishing agent or a unit for generating infrasound.

In a further embodiment of the invention, the extinguishing agent is ejected from the forest fire detection unit. The forest fire detection unit contains extinguishing agents, such as water or a foam extinguishing agent, which are ejected. Depending on the extent of the fire and its direction and speed of propagation, the ejection may occur multiple times.

In a further embodiment of the invention, the forest fire detection unit returns to the forest fire detection station after ejecting the extinguishing agent. At the forest fire detection station, the forest fire detection unit can be reloaded and refueled with extinguishing agent.

In a further development of the invention, the forest fire detection unit couples to the forest fire detection station after returning to the forest fire detection station. The forest fire detection unit is put into sleep mode to save energy.

In a further embodiment of the invention, the coupling comprises the connection of the forest fire detection unit to the forest fire detection station. By connecting to the forest fire detection station, the forest fire detection unit can be recharged and refueled with extinguishing agent, data and information can be exchanged and, if necessary, a software update can be carried out.

In a further embodiment of the invention, the connection of the forest fire detection unit to the forest fire detection station comprises a connection of the forest fire detection unit to a power supply. The forest fire detection unit is preferably a flight-capable drone with electric propulsion. The forest fire detection unit can be supplied with electrical energy again by means of a power supply arranged in the forest fire detection station.

In a further development of the invention, the forest fire detection unit is provided with energy. The forest fire detection unit is preferably a flight-capable drone with electric propulsion. The forest fire detection unit can be supplied with electrical energy again by means of a power supply arranged in the forest fire detection station.

In a further embodiment of the invention, the connection of the forest fire detection unit to the forest fire detection station comprises a connection of the forest fire detection unit to a reservoir of extinguishing agent. The extinguishing agent is, for example, water or a foam extinguishing agent, which is stored in disposable containers in the forest fire detection station.

In a further embodiment of the invention, the forest fire detection unit is loaded with extinguishing agent. The extinguishing agent is, for example, water or a foam extinguishing agent, which is stored in ejectable containers in the forest fire detection station or is ejected directly. After the fire source has been detected, the forest fire detection unit is recharged with extinguishing agent and is ready for use again.

In a further development of the invention, the decoupling includes the disconnection of a connection to the energy (power) supply. The forest fire detection unit is preferably a flight-capable drone with an electric drive that is powered by a rechargeable energy storage device (battery) arranged in the forest fire detection unit.

The object is also achieved with the autonomous forest fire detection unit according to the invention. Advantageous embodiments of the invention are also set out in the dependent claims.

The autonomous forest fire detection unit according to the invention has a navigation unit, an autonomous control unit and a locating unit. The navigation unit has navigation sensors to detect objects in the environment. The navigation sensors particularly detect obstacles that may occur during movement of the forest fire detection unit. The forest fire detection unit is therefore able to bypass these obstacles. The control unit is designed as a microcontroller and has memory and microprocessor with control software. The locating unit has suitable sensors for locating a forest fire. This is preferably an IR sensor and/or an IR camera.

In a further development of the invention, the autonomous forest fire detection unit has a drive. The forest fire detection unit is preferably a flight-capable drone that automatically detects a fire source. The drive is preferably electric and has an electric motor and a rotor with which the autonomous forest fire detection unit can be driven.

In a further embodiment of the invention, the autonomous forest fire detection unit has a controllable steering. The autonomous forest fire detection unit can be steered by pivoting the rotors and varying the speed of the individual propulsion motors.

In a further embodiment of the invention, the autonomous forest fire detection unit has a detection unit which is intended and suitable for detecting a fire source. Preferably, the detection uses an image-capturing method, preferably a thermal image of the fire source is captured.

In a further embodiment of the invention, the detection unit comprises a detection sensor unit which is intended and suitable for detecting a forest fire. Preferably, the detection uses an image-capturing method, preferably a thermal image of the fire source is captured.

In a further aspect of the invention, the detection unit comprises a locating sensor unit which is intended and suitable for locating a forest fire. The locating sensor unit can be used to determine the position of the fire source relative to the locating sensor unit of the forest fire detection unit. In addition, the position of the locating sensor unit of the forest fire detection unit can be determined by means of a navigation satellite system, e.g. GPS.

In a further embodiment of the invention, the locating sensor unit, the detection sensor unit, the drive, the controllable steering, the navigation unit, the navigation sensors and/or the communication unit are coupled to the autonomous control unit. The control unit of the forest fire detection unit executes control commands for detecting a fire source, for locating a fire source, for moving the forest fire detection unit, for navigating the forest fire detection unit, for steering the forest fire detection unit and/or for ejecting extinguishing agents. The control unit is designed as a microcontroller and has memory and microprocessor with control software.

In a further embodiment of the invention, the autonomous control unit has a memory in which a program executable by the autonomous control unit is stored, which enables the autonomous operation of the autonomous forest fire detection unit.

In a further embodiment of the invention, the autonomous control unit has a software program for controlling an autonomous forest fire detection unit.

The object is also achieved with the forest fire detection station according to the invention. Advantageous embodiments of the invention are also set out in the dependent claims.

The forest fire detection station according to the invention has a receiving device, an energy source and a holder for a movable forest fire detection unit. The forest fire detection station is designed to accommodate the forest fire detection unit and has all-round weather protection that can be opened or closed at the top. The top has an energy conversion device. An energy storage (battery) is arranged on the underside, which storage is charged with electrical energy by the energy conversion device.

In a further development of the invention, the forest fire detection station has a receiver, an energy source and/or an extinguishing device. The receiver is designed to receive information, particularly on the position of a detected fire source. The energy source is preferably a photovoltaic system with an energy storage. The extinguishing device has a plurality of detachable containers with extinguishing agent, e.g. a foam extinguishing agent. Alternatively, the extinguishing agent is dropped directly.

In a further embodiment of the invention, the forest fire detection station comprises a mobile forest fire detection unit. The forest fire detection unit is designed as a preferably autonomous flight-capable drone and has a drive unit with a plurality of rotors driven by motors for this purpose. The motors are usually electric motors and are powered by a rechargeable energy storage (battery).

In a further embodiment of the invention, the forest fire detection station and/or the forest fire detection unit comprises an extinguishing agent reservoir. The extinguishing agent reservoir has a plurality of ejectable containers with extinguishing agent, e.g. a foam extinguishing agent, which can be arranged in the mobile forest fire detection unit. Alternatively, the extinguishing agent is pumped into a tank of the forest fire detection unit.

In an advantageous embodiment of the invention, the forest fire detection station and/or the forest fire detection unit comprises a power connection and/or an energy conversion device. The energy source is preferably a photovoltaic system with an energy storage, so that the forest fire detection station can be installed independently of a power supply.

In a further development of the invention, the forest fire detection station and/or the forest fire detection unit comprises an energy storage. The energy storage (battery) is charged with electrical energy by the energy conversion device.

In a further embodiment of the invention, the forest fire detection station comprises weather protection for the forest fire detection unit. The forest fire detection unit arranged in the forest fire detection station as well as the components arranged in the forest fire detection station are therefore protected from weather conditions.

In a further aspect of the invention, the forest fire detection station comprises a holder for the forest fire detection unit. The forest fire detection unit can be coupled to the forest fire detection station via the holder. The holder is designed to be connected to the energy storage of the forest fire detection unit in order to charge the energy storage of the forest fire detection unit with electrical energy.

In a further embodiment of the invention, the forest fire detection station and/or the forest fire detection unit comprises a control unit. The control unit has a memory in which a program executable by the control unit is stored, which program enables the operation of the forest fire detection station.

In a further embodiment of the invention, the forest fire detection station and/or the forest fire detection unit comprises a communication unit. The communication unit is used to receive information, e.g. position data of a detected fire source, and to send information, e.g. data on the status of the forest fire detection station.

The object is also achieved with the method according to the invention for detecting and/or locating a forest fire with a forest fire detection station. Advantageous embodiments of the invention are set out in the dependent claims.

The method according to the invention for detecting and/or extinguishing a forest fire with a forest fire detection station has four steps: In the first step, information is received. The information includes, for example, the detection of a forest fire, its position and, if applicable, its speed and direction of propagation. In the second step, a control command is generated The control command contains the received information and commands for detecting a forest fire. In the third step, a control command and/or information is sent. In the fourth step, a forest fire detection process is carried out.

In a further development of the invention, the reception of information takes place on a server unit. The server unit is part of a network for detecting and reporting forest fires. The network preferably is a LoRaWAN network that has a star-shaped architecture in which message packets are exchanged between the first forest fire detection sensors and a central server unit by means of gateways.

In a further embodiment of the invention, the information is sent from a terminal. The forest fire detection sensor is part of a terminal and is arranged in it. The terminals are connected to gateways via a single-hop connection.

In a further embodiment of the invention, the information is sent via a network. The network preferably is a LoRaWAN network that has a star-shaped architecture in which message packets are exchanged between terminals and a central server unit by means of gateways.

In a further embodiment of the invention, the information contains the result of an analysis. The analysis is, for example, a gas analysis and a recording of the temperature of the gases that are produced during a forest fire. In addition to heavy smoke, a forest fire produces a plurality of gases, particularly carbon dioxide and carbon monoxide. The type and concentration of these gases are characteristic of a forest fire and can be detected and analyzed using suitable sensors.

In a further embodiment of the invention, the analysis is carried out using measurement data from a sensor. The sensor is, for example, a sensor array for gas analysis, for recording the temperature of the gases and for recording the prevailing wind direction and speed.

In a further aspect of the invention, the measurement data are recorded on the terminal. The sensor is part of a terminal and is arranged in it.

In a further development of the invention, the analysis is carried out on the terminal or the server unit. A software program is stored in memory on the server unit, which program can be used to perform the analysis automatically.

In a further embodiment of the invention, the control command or information for generating a control command is generated from the information. The control command initiates the detection of a forest fire.

In a further embodiment of the invention, the control command or the information for generating a control command is sent. The control command, preferably generated on the server unit, is sent to the forest fire detection device via IP connection and cable.

In a further embodiment of the invention, the control command or the information for generating a control command is sent from the server unit to the forest fire detection device. The control command, preferably generated on the server unit, is sent to the forest fire detection device via IP connection and cable, and the process for detecting a detected forest fire is initiated.

In a further development of the invention, sending is carried out via a network. The network preferably is a LoRaWAN network that has a star-shaped architecture in which message packets are exchanged between the first forest fire detection sensors and a central server unit by means of gateways.

In a further embodiment of the invention, the forest fire detection process comprises a first positioning of a forest fire detection unit. The forest fire detection unit is positioned near the fire source in such a way that the forest fire detection unit detects the fire source by means of a suitable sensor, preferably an infrared camera.

In a further embodiment of the invention, the forest fire detection process includes locating the fire source. The forest fire detection unit is positioned near the fire source in such a way that the forest fire detection unit detects the fire source by means of a suitable sensor, preferably an infrared camera.

In a further embodiment of the invention, the forest fire detection process comprises the ejection of a forest fire detection agent. The extinguishing agent is dropped by the forest fire detection unit onto or within a radius around the fire source. Alternatively, the forest fire can also be fought with infrasound.

The object is also achieved with the forest fire detection system according to the invention. Advantageous embodiments of the invention are also set out in the dependent claims.

The forest fire detection system according to the invention comprises a network device, a server unit and a gateway. The forest fire detection system features a mesh gateway network that uses LoRaWAN network technology. The LoRaWAN network has a star-shaped architecture in which message packets are exchanged between the sensors and a central Internet network server by means of gateways.

The forest fire detection system has a large number of sensors, which are connected to gateways via a single-hop connection. The gateways are usually front-end gateways. The front-end gateways are connected to each other and partly to border gateways. A border gateway can also be combined with a front-end gateway to form a mesh gateway device in one device. The border gateways are connected to the Internet network server, either via a wired connection or via a wireless connection by means of the Internet protocol.

The forest fire detection system according to the invention also has a first terminal, wherein the first terminal has a sensor unit.

The forest fire detection system according to the invention additionally has a second terminal, wherein the second terminal has a forest fire detection element.

In a further development of the invention, the network is a LoRaWAN network with a server, gateway, a first terminal, and a second terminal different from the first terminal. The second terminal is preferably a forest fire detection unit having a sensor for detecting a forest fire and a device for detecting a forest fire.

In a further embodiment of the invention, the first terminal has a sensor unit and/or the second terminal has a forest fire detection unit. The second terminal is preferably a forest fire detection unit having a sensor for detecting a forest fire and a device for detecting a forest fire.

In a further embodiment of the invention, the first terminal is arranged in a fixed location, e.g. on a tree in the forest to be monitored.

In a further embodiment of the invention, the first terminal has a sensor for forest fire detection, a communication device, an energy storage and/or an energy conversion device. The first terminal can thus be operated independently and can be connected to the central network server via the communication device. The sensor is a sensor for gas analysis, for recording the temperature of the gases and for recording the prevailing wind direction and speed.

In a further embodiment of the invention, the second terminal is mobile, e.g. a flight-capable drone.

In a further embodiment of the invention, the second terminal has a sensor for forest fire detection, a navigation device, a drive and/or an energy storage. The navigation sensors have one or a plurality of cameras and/or time-of-flight based sensors that detect obstacles during the movement of the second terminal. The second terminal is therefore able to circumvent these obstacles.

In a development of the invention, the sensor of the first terminal is different from the sensor of the second terminal. The first detection of the forest fire using the first terminal is preferably occurs by detecting and analyzing the gases (smoke) produced by a forest fire and their temperature. The second detection uses a different method than the first detection, e.g. an image capture method or a method for detecting particles. Using an image capture method, the fire source can be detected more precisely, in particular, the extent of the fire source and its direction of propagation can be recorded more precisely. The imaging process preferably produces a thermal image of the fire source.

In a further embodiment of the invention, the network has a central server. An executable program that controls the detection of a forest fire is stored in memory on the central server.

In a further embodiment of the invention, the network has a plurality of gateways, wherein the gateways are mesh gateways and/or border gateways. Message packets are exchanged between the sensors and a central Internet network server by means of gateways. The mesh-gateways are connected to each other and partly to border gateways. The border gateways are connected to the Internet network server NS, either via a wired connection or via a wireless connection by means of the Internet protocol IP.

The object is also achieved with the forest fire detection unit according to the invention. Advantageous embodiments of the invention are set out in the dependent claims.

The forest fire detection unit according to the invention has a drive and a detection unit which is intended and suitable for detecting a fire source. The forest fire detection unit is preferably designed as an autonomous flight-capable drone and has a propulsion unit with a plurality of rotors driven by motors. The motors are usually electric motors and are powered by a rechargeable energy storage device (battery). The detection unit is preferably an infrared camera for capturing thermal images. In addition, the forest fire detection unit according to the invention has a navigation unit and a locating unit. The locating unit has suitable sensors for locating the forest fire. The navigation unit detects objects in the vicinity of the forest fire detection unit.

In a development of the invention, the detection unit has a detection sensor unit which is intended and suitable for recognizing a forest fire. The detection unit is preferably an infrared camera for capturing thermal images.

In a further embodiment of the invention, the detection unit has a locating sensor unit which is intended and suitable for locating a forest fire. The locating sensor unit can be used to determine the position of the fire source relative to the locating sensor unit of the forest fire detection unit. In addition, the position of the locating sensor unit of the forest fire detection unit can be determined by means of a navigation satellite system, e.g. GPS.

In a further embodiment of the invention, the locating sensor unit is coupled to a control unit. The control unit has a program stored in a memory for automatically locating a forest fire.

In a further embodiment of the invention, the detection unit is coupled to the control unit. The control unit has a program stored in a memory for automatically detecting a forest fire.

In a particularly advantageous embodiment of the invention, the forest fire detection unit has a flight drive. The forest fire detection unit is designed as a preferably autonomous flight-capable drone and has a propulsion unit with a plurality of rotors driven by motors.

The object is also achieved with the method according to the invention for detecting and/or locating a forest fire with a forest fire detection station. Advantageous embodiments of the invention are also set out in the dependent claims.

The method according to the invention for detecting and/or locating a forest fire with a forest fire detection station has three steps: In the first step, information is received. The information includes, for example, the detection of a forest fire, its position and, if applicable, its speed and direction of propagation. In the second step, a forest fire detection unit is decoupled from a forest fire detection station. The forest fire detection station is a weatherproof station for housing the forest fire detection unit. In standby mode, the forest fire detection unit is immovably coupled to the forest fire detection station. In the third step, a forest fire detection process is started to detect and/or locate a forest fire, for example by using a flight-capable drone as a forest fire detection unit. Automatic detection and/or locating of a fire source can therefore begin immediately after a fire source has been detected.

In a further development of the invention, the forest fire detection process comprises starting the forest fire detection unit. In standby mode, the forest fire detection unit is immovably coupled to the forest fire detection station. The forest fire detection unit is designed as an autonomous flight-capable drone and is launched from the forest fire detection station at the beginning of the forest fire detection process.

In a further embodiment of the invention, the forest fire detection process comprises moving the forest fire detection unit in a first position. The forest fire detection unit is positioned near the fire source in such a way that the forest fire detection unit detects the fire source by means of a suitable sensor, preferably an infrared camera and allows detection of the forest fire.

In a further embodiment of the invention, the first position after moving the forest fire detection unit has a different distance to the forest fire than the forest fire detection station. Typically, the distance of the forest fire detection station to the forest fire is greater than the distance of the forest fire detection unit to the forest fire.

In a further embodiment of the invention, the forest fire detection process comprises the detection of a forest fire by the forest fire detection unit. Using a sensor, e.g. an infrared camera, the forest fire detection unit detects the fire source.

In a further embodiment of the invention, the forest fire detection process comprises locating a forest fire through the forest fire detection unit. Through the locating sensor unit of the forest dire detection unit the position of the fire source relative to the locating sensor unit of the forest fire detection unit can be determined.

In a development of the invention, locating occurs with an image-capturing method, preferably a thermal image of the fire source is captured.

In a further embodiment of the invention, after the forest fire has been located by the forest fire detection unit, the forest fire detection unit is moved to a second position. In the second position, the forest fire detection unit is positioned so that detection of a forest fire is possible.

In a further embodiment of the invention, the extinguishing process takes place after the first and/or second position of the forest fire detection unit is reached. For this purpose, an extinguishing agent is ejected, which is arranged in the forest fire detection unit.

In a further development of the invention, the extinguishing process takes place several times. Depending on the extension of the fire source and its direction and speed of propagation, the extinguishing process is carried out several times in order to completely extinguish the forest fire.

In a further embodiment of the invention, after an extinguishing process has been carried out, the forest fire detection unit is moved to the forest fire detection station. After detecting the fire source, especially after dropping the extinguishing agent, the forest fire detection unit returns to the forest fire detection station in order to be refueled and filled with extinguishing agent. Refueling can take the form of energy, for example when a forest fire is fought with infrasound.

In a further embodiment of the invention, the forest fire detection unit is coupled to the forest fire detection station. The forest fire detection unit is coupled to the forest fire detection station in such a way that the forest fire detection unit is connected to the power supply of the forest fire detection station.

In an advantageous development of the invention, after coupling the forest fire detection station with the forest fire detection unit, the forest fire detection unit is charged with energy and/or extinguishing agent from the forest fire detection station. The forest fire detection unit is refueled with electrical energy. In addition, the forest fire detection unit is connected to the extinguishing agent reservoir of the forest fire detection station. The forest fire detection unit is also loaded with extinguishing agent.

In an advantageous embodiment of the invention, the forest fire detection system has a forest fire detection station. The forest fire detection station is a weatherproof station for housing the forest fire detection unit.

In a further embodiment of the invention, the forest fire detection unit comprises the second sensor, a drive unit, an energy unit, a navigation unit, a steering unit, a control unit, a communication unit and/or a locating unit. The forest fire detection unit is preferably a flying drone that automatically detects a fire source.

In a development of the invention, the navigation unit has navigation sensors for detecting objects in the environment. The navigation sensors particularly detect obstacles that may occur during movement of the forest fire detection unit. The forest fire detection unit is therefore able to bypass these obstacles.

In a further development of the invention, the navigation sensors are cameras and/or time of flight measurement based sensors. The navigation sensors comprise one or a plurality of cameras and/or time-of-flight based sensors that detect obstacles during the movement of the forest fire detection unit. The obstacles are detected, recognized and analyzed by the control unit arranged in the forest fire detection unit in such a way that the forest fire detection unit automatically avoids the obstacles during movement.

In a further embodiment of the invention, the sensors based on time-of-flight measurement are radar, ultrasonic and/or LiDAR sensors. The navigation sensors comprise one or a plurality of cameras and/or time-of-flight based sensors (such as radar, ultrasound, LIDAR) that detect obstacles during the movement of the forest fire detection unit. The obstacles are detected, recognized and analyzed by the control unit arranged in the forest fire detection unit in such a way that the forest fire detection unit automatically avoids the obstacles during movement.

In a further embodiment of the invention, the forest fire detection unit can be controlled autonomously. The forest fire detection unit is preferably unmanned and enables automatic and/or autonomous detection of a fire source.

In an advantageous embodiment of the invention, the forest fire detection unit has an extinguishing agent reservoir. The extinguishing agent is, for example, water or a foam extinguishing agent.

In a further embodiment of the invention, the forest fire detection unit has a dispensing and/or ejection device for extinguishing agents. The extinguishing agent is ejected from the extinguishing agent reservoir onto the fire source.

In a further embodiment of the invention, the forest fire detection station has a holder which is intended and suitable for receiving the forest fire detection unit. The forest fire detection station is designed to be connected to, for example, an energy storage of the forest fire detection unit in order to supply the energy storage of the forest fire detection unit with electrical energy.

In a further aspect of the invention, the forest fire detection station has a control unit, a weather protection unit, an energy storage, an extinguishing agent reservoir and/or a communication unit. The forest fire detection station is designed to be connected to, for example, an energy storage of the forest fire detection unit in order to supply the energy storage of the forest fire detection unit with electrical energy. In addition, the forest fire detection unit is filled with extinguishing agent.

In a development of the invention, the information includes position data, in particular the position of a forest fire and the position of a forest fire detection unit.

Exemplary embodiments of the method according to the invention, for autonomously detecting and/or locating a forest fire and of the forest fire detection system according to the invention are shown schematically in simplified form in the drawings and are explained in more detail in the following description.

### IN PARTICULAR

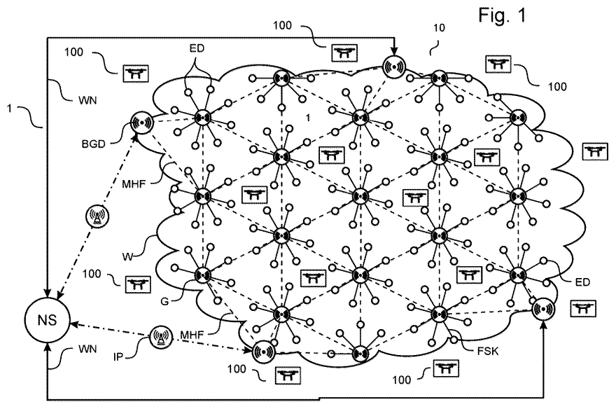

FIG. 1 shows a forest fire detection system

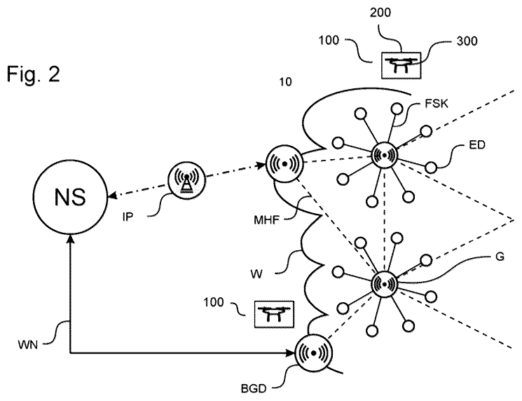

FIG. 2 shows a detailed view of the forest fire detection system according to the invention

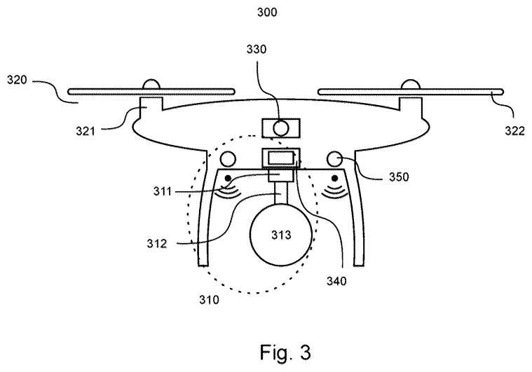

FIG. 3 shows the forest fire detection unit

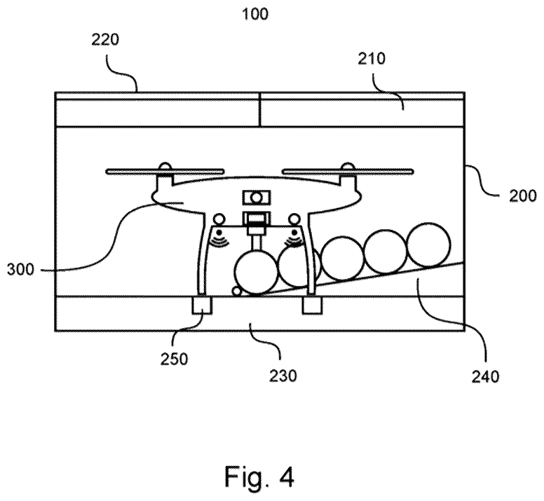

FIG. 4 shows the forest fire detection device

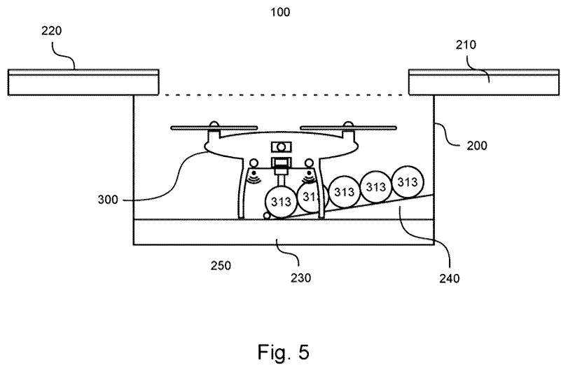

FIG. 5 shows the forest fire detection device, open

An embodiment of a forest fire detection system 1 according to the invention, arranged in a forest W to be monitored, is shown in FIG. 1. The LoRaWAN mesh gateway network 1 has a mesh gateway network 1 that uses the technology of a LoRaWAN network. The LoRaWAN network 1 has a star-shaped architecture in which message packets are exchanged between the first forest fire detection sensors ED and a central Internet network server NS by means of gateways. The first forest fire detection sensor is part of a terminal and is arranged in it. In this document, the terminal ED and the first forest fire detection sensor are therefore used synonymously with the same reference numeral.

The LoRaWAN mesh gateway network 1 has a plurality of first forest fire detection sensors ED, which are connected to gateways G via a single-hop connection FSK. The gateways G are usually mesh gateways MGD. The mesh gateways MGD are connected to each other and partly to border gateways BGD. The border gateways BGD are connected to the Internet network server NS, either via a wired connection WN or via a wireless connection using the Internet protocol IP.

A plurality of forest fire detection devices 100 are arranged in and around the forest W. Each forest fire detection device 100 has a forest fire detection station 200 and a mobile forest fire detection unit 300 (see FIG. 4).

For the autonomous detection of a forest fire, a first detection of a forest fire is carried out by one or more of the fixed first forest fire detection sensors ED. The first forest fire detection sensor ED has a sensor array for gas analysis, for recording the temperature of the gases and for recording the prevailing wind direction and speed. Alternatively or additionally, the sensor array can also record or receive signals on the prevailing wind direction from external measuring devices.

In the next step, the forest fire is located by means of an initial locating. The first locating is carried out with the first forest fire detection sensor ED that detects the forest fire, in other words the position of the forest fire detection sensor ED that detects the forest fire marks the location of the forest fire. In addition, the first locating is carried out by means of a plurality of first forest fire detection sensors ED: A plurality of ED terminals each detect a signal, the source of which is the gases generated by the forest fire, as well as the individual times of detection of the three individual signals. Based on these three detected signals and the recorded times of their detection, the position of the forest fire is determined. In addition, the wind speed and direction are included in the initial locating of the forest fire, which can be detected using the first forest fire detection sensor ED.

To perform the first locating, the position of each first forest fire detection sensor ED must be known as precisely as possible. The position determination can be done, for example, when installing the first forest fire detection sensor ED. The first forest fire detection sensor ED can, for example, be arranged on a tree in the forest to be monitored and the position of the first forest fire detection sensor ED can be determined once using a navigation satellite system, such as GPS (global positioning system). For this purpose, a commercially available GPS system or a smartphone can be used.

It is also possible to determine the position of a first forest fire detection sensor ED using a suitable receiver. The first forest fire detection sensor ED receives signals from at least four, usually six sources for positioning, in the case of using the GPS navigation satellite system, radio signals on the L1 frequency (1575.42 MHZ). The sources are satellites that constantly broadcast their current position and the exact time. The determined position of the first forest fire detection sensor ED is stored on the network server NS and optionally additionally in the control unit of the first forest fire detection sensor ED whose position was determined in this way, also permanently stored.

Alternatively or additionally, the position determination of a first forest fire detection sensor ED can be determined and stored continuously or at intervals using the navigation satellite system. The position of a first forest fire detection sensor ED is then regularly checked and updated. The network server NS has a first control in the form of a software program on a memory, by means of which the position of a fire source can be determined.

Based on the first locating of the forest fire by means of the first forest fire detection sensors ED, a second forest fire detection sensor 330 is positioned near the fire source such that the distance of the second forest fire detection sensor 330 to the fire source is less than the distance of a first forest fire detection sensor ED at the time of the first detection of the forest fire. For this purpose, the second forest fire detection sensor 330 is arranged in a mobile and autonomously controllable flight-capable forest fire detection unit 300 (see FIG. 3). The forest fire detection unit 300 is arranged, as part of a forest fire detection device 100 (see FIG. 4, 5) in a forest fire detection station 200.

Before, during and after positioning the second forest fire detection sensor 330 near the forest fire, a second detection is performed using the second forest fire detection sensor 330. For the second detection, a different method is used than for the first detection: While the first detection uses the first forest fire detection sensor ED to carry out a gas analysis and to record the temperature of the gases, the second detection uses an image-capturing method, preferably for capturing a thermal image of the fire source.

A second locating of the fire source is carried out by means of the second forest fire detection sensor 330. For this purpose, the measured values recorded by the second forest fire detection sensor 330 are used, in particular the thermal image of the fire source. The forest fire detection unit 300 has a locating system (see FIG. 3), with which the position of the fire source is determined relative to the locating system of the forest fire detection unit 300. In addition, the position of the locating system of the forest fire detection unit 300 is determined by means of a navigation satellite system, e.g. GPS, and continuously updated. Alternatively or additionally, a triangulation method is used in which the distance to stationary elements of the forest fire detection system 1, e.g. the first forest fire detection sensors ED and/or the gateways G, MGD, BGD, is determined.

This second locating of the fire source is advantageously more accurate than the first locating of the fire source by means of the first forest fire detection sensors ED. The fire source is therefore more precisely located and can be fought more specifically. In addition to the second locating of the fire source, the forest fire detection unit 300 transmits additional information about, for example, the extent of the fire source to the network server NS, in addition to the first locating, either via a direct connection between the forest fire detection unit 300 and the Internet network server NS and/or via a connection between the forest fire detection unit 300 and one or more gateways G, MGD, BGD. The forest fire detection unit 300 has a second control and a communication unit.

The positioning of the second forest fire detection sensor 330, the second detection and second locating of the fire source usually takes place several times over a period of time. The position, extent, direction and speed of propagation of the fire are therefore continuously recorded and updated.

After the second locating, the forest fire is detected and/or extinguished using the forest fire detection unit 300. The forest fire detection unit 300 has an extinguishing unit 310 (see FIG. 3). The extinguishing unit 310 has extinguishing agents, e.g. water or a foam extinguishing agent, which are ejected. Depending on the extent of the fire and its direction and speed of propagation, the ejection may occur several times. In particular, the extinguishing agent 310 can be applied in different directions in order to contain the fire source or to extinguish it efficiently.

The positioning of the second forest fire detection sensor 330, the second detection and second locating of the fire source and the forest fire detection and/or extinguishing can also be carried out simultaneously and in parallel by means of a plurality of forest fire detection units 300, depending on the extent and the direction and speed of propagation of the fire source.

A detailed view of a forest fire detection system 10 according to the invention is shown in FIG. 2. The forest fire detection system 10 has a plurality of first forest fire detection sensors ED wherein respective eight first forest fire detection sensors ED communicate with a gateway G via a single-hop connection FSK. The gateways FGD are connected to each other and to border gateways BGD. The border gateways BGD are connected to the Internet network server NS, either via a wired connection WN or via a wireless connection using the Internet protocol IP. A plurality of forest fire detection devices 100 are arranged around the forest W to be monitored.

FIG. 3 shows an exemplary embodiment of the forest fire detection unit 300 according to the invention. The forest fire detection unit 300 is designed as an autonomous flight-capable drone and has for this purpose a drive unit 320 with a plurality of rotors 322 driven by motors 321. The motors 321 are usually electric motors and are powered by a rechargeable energy storage (battery). The forest fire detection unit 300 is controlled by pivoting the rotors 322 and varying the speed of the individual motors 321.

For the second locating of a fire source, the forest fire detection unit 300 has the second forest fire detection sensor 330, which in this exemplary embodiment is an infrared camera. In addition, the forest fire detection unit 300 in this exemplary embodiment has a further forest fire detection sensor 340, which is designed as a gas sensor.

To detect the source of a fire, the forest fire detection unit 300 has the extinguishing unit 310, which has the extinguishing agent holder 311 for holding the extinguishing agent 313. By means of the extinguishing agent ejection device 312, the extinguishing agent 313 can be ejected to detect and extinguish a fire source.

The forest fire detection unit 300 according to the invention also has a navigation sensor 350 which detects objects in the vicinity of the forest fire detection unit 300. The navigation sensor 350 has one or a plurality of cameras and/or time-of-flight based sensors (such as radar, ultrasound, LIDAR) that detect obstacles during the flight of the forest fire detection unit 300. The obstacles are detected, recognized and analyzed by the control unit arranged in the forest fire detection unit 300 in such a way that the forest fire detection unit 300 automatically avoids the obstacles during its flight.

All of the above components are connected to a second control unit of the forest fire detection unit 300 and are controlled by the second control unit.

An exemplary embodiment of a forest fire detection device 100 is shown in FIG. 4 and FIG. 5. The forest fire detection device 100 has the main components forest fire detection station 200 and the forest fire detection unit 300 (see FIG. 3).

The forest fire detection station 200 is designed to accommodate the forest fire detection unit 300 and has all-round weather protection 210 that can be opened or closed at the top. The top side has an energy conversion device 220, which in this embodiment is a photovoltaic system. An energy storage (battery) 230 is arranged on the underside, which storage is charged with electrical energy by the energy conversion device 220.

The forest fire detection station 200 has a holder 250 for receiving the forest fire detection unit 300, via which the forest fire detection unit 300 is coupled to the forest fire detection station 200. The holder 250 is designed to be connected to the energy storage of the forest fire detection unit 300 in order to charge the energy storage of the forest fire detection unit 300 with electrical energy.

The extinguishing agent reservoir 240 is arranged on an inclined plane at the bottom of the forest fire detection station 200. In this embodiment, the extinguishing agent 313 is a foam extinguishing agent that is filled into a plurality of disposable containers. Such containers are sold by Rain Industries Inc. One or more containers are dropped onto the fire source by the forest fire detection unit 300, due to the heat generated, the plastic wall of the container bursts and the extinguishing agent 313 is applied. Another possibility is to use water-filled containers. Alternatively, the forest fire detection unit 300 can have an acoustic cannon as an extinguishing agent 313, which fights a fire by means of the air pressure fluctuations caused by the sound pressure. The sound waves with a frequency of 30 to 60 Hz trigger mechanical vibrations in the area around the fire, which affect both the burning material and the oxygen supply. Extinguishing using an acoustic cannon is particularly sustainable, does not produce any waste during extinguishing, does not require water or chemicals that may be problematic for forest soil, and can be carried out as long as the energy storage of the forest fire detection unit 300 has energy.

To detect a forest fire, after the first detection and locating of the fire source by a stationary first forest fire detection sensor ED (see FIG. 1) the second forest fire detection sensor 330 and thus the forest fire detection unit 300 is moved to the fire source for the purpose of the second detection, the second locating and the forest fire detection. To this end a route is determined on the network server NS. The route includes the current position of the forest fire detection unit 300 as part of the forest fire detection station 200 as well as the position of the target area, in particular the position of the fire source. The forest fire detection device 100 has a communication unit that is connected to the network server NS and receives and sends information about the extent of the fire source and position data. The forest fire detection unit 300 is then decoupled from the forest fire detection station 200 and the motor 321 of the forest fire detection unit 300 is started. At the same time, the weather protection 210 of the forest fire detection station 200 is opened (FIG. 5).

The forest fire detection unit 300 then moves in a motorized manner along the calculated route to the target area of the fire source. The forest fire detection unit 300 continuously detects, by means of the navigation sensor 350, any obstacles that may occur, determines an alternative route to the target area when obstacles occur using the second control, and continues the motorized movement along the alternative route to the target area, wherein a detection of obstacles, the determination of an alternative route, and motorized movement along the alternative route are continuously repeated and carried out during the movement of the forest fire detection unit 300.

In the target area, the second detection and the second locating of the fire source as well as the detection or extinguishing of the fire source takes place by means of the forest fire detection unit 300 by ejecting the extinguishing agent 313. The second control of the forest fire detection unit 300 generates and/or executes control commands for the second detection of a fire source, for second locating a fire source, for moving the forest fire detection unit 300, for navigating the forest fire detection unit 300, for steering the forest fire detection unit 300 and/or for ejecting extinguishing agents 313.

The second control of the forest fire detection unit 300 has a memory in which an executable program is stored by the second control, which program enables the autonomous operation of the autonomous forest fire detection unit. Second detection of the fire source, second locating of the fire source and ejection of the extinguishing agent 313 are advantageously carried out completely or at least partially autonomously by means of the described method according to the invention for detecting and/or locating a forest fire.

After detecting the fire source, in particular after locating and ejecting extinguishing agent 313, the forest fire detection unit 300 returns to a forest fire detection station 200 and couples to the holder 250 in such a way that the forest fire detection unit 300 is connected to the energy supply (energy storage 230) of the forest fire detection station 200. Thereafter the forest fire detection unit 300 is provided with energy In addition, the forest fire detection unit 300 is connected to the extinguishing agent reservoir 240. The forest fire detection unit 300 is also loaded with extinguishing agent 313. In addition, the weather protection 210 is closed (FIG. 4), the forest fire detection station 200 is ready for use again.

5 In addition, the forest fire detection station 200 also has a control unit that controls the energy conversion device 220, the provision of the forest fire detection unit 300 with extinguishing agent 313 from the extinguishing agent reservoir 240 and the take-off or landing of the forest fire detection unit 300 as well as the opening and closing of the weather protection 210.

### LIST OF REFERENCE NUMERALS

1 Forest fire detection system
10 LoRaWAN mesh gateway network
ED Terminal/First forest fire detection sensor
G Gateway
NS Internet Network Server
IP Internet protocol
MHF Multi-hop wireless network
MDG Mesh gateways
BGD Border gateway
FSK FSK modulation
WN Wired connection
W Forest
100 Forest fire detection device
200 Forest fire detection station
210 Weather protection
220 Energy conversion unit
230 Energy storage
240 Extinguishing agent reservoir
250 Holder for forest fire detection unit
300 Forest fire detection unit
310 Extinguishing unit
311 Holder for extinguishing agent
312 Extinguishing agent ejection device
313 Extinguishing agent
320 Flight propulsion/drive unit
321 Motor
322 Rotor
330 Second forest fire detection sensor/IR camera
340 Forest fire detection sensor
350 Navigation sensor

1. A method for detecting and/or locating a forest fire using a forest fire detection station, comprising the steps
receiving information,
generating a control command
sending the control command and/or information
carrying out the forest fire detection process.

2. The method for detecting and/or locating a forest fire with a forest fire detection station according to claim 1,
characterized in that
receiving information occurs on a server unit.

3. The method for detecting and/or locating a forest fire with a forest fire detection station according to claim 2,
characterized in that
the information is sent from a terminal.

4. The method for detecting and/or locating a forest fire with a forest fire detection station according to claim 2,
characterized in that
sending information occurs over a network.

5. The method for detecting and/or locating a forest fire with a forest fire detection station according to claim 1,
characterized in that
the information contains the result of an analysis.

6. The method for detecting and/or locating a forest fire with a forest fire detection station according to claim 5,
characterized in that
the analysis is carried out from measurement data of a sensor.

7. The method for detecting and/or locating a forest fire with a forest fire detection station according to claim 6,
characterized in that
the measurement data is recorded on the terminal.

8. The method for detecting and/or locating a forest fire with a forest fire detection station according to claim 1,
characterized in that
the analysis takes place on the terminal or the server unit.

9. The method for detecting and/or locating a forest fire with a forest fire detection station according to claim 1,
characterized in that
the control command or information for generating a control command is generated from the information.

10. The method for detecting and/or locating a forest fire with a forest fire detection station according to claim 9,
characterized in that
the control command or the information for generating a control command is sent.

11. The method for detecting and/or locating a forest fire with a forest fire detection station according to claim 10,
characterized in that
the sending of the control command or the information for generating a control command occurs from the server unit to the forest fire detection device.

12. The method for detecting and/or locating a forest fire with a forest fire detection station according to claim 10,
characterized in that
sending takes place over a network.

13. The method for detecting and/or locating a forest fire with a forest fire detection station according to claim 1,
characterized in that
the forest fire detection process comprises a first positioning of a forest fire detection unit.

14. The method for detecting and/or locating a forest fire with a forest fire detection station according to claim 13,
characterized in that
the forest fire detection process comprises locating the fire source and/or the forest fire detection process comprises changing the position of the forest fire detection unit.

15. The method for detecting and/or locating a forest fire with a forest fire detection station according to claim 1,
characterized in that
the forest fire detection process comprises the ejection of a forest fire detection agent.

16. A forest fire detection system having
a network device
a server unit
a gateway
a first terminal, wherein the first terminal has a sensor unit
a second terminal, wherein the second terminal has a forest fire detection element.

17. The forest fire detection system according to claim 16,
characterized in that
the network is a LoRaWAN network with a server, gateway, a first terminal, and a second terminal different from the first terminal.

18. The forest fire detection system according to claim 17,
characterized in that
the first terminal has a sensor unit and/or the second terminal has a forest fire detection unit.

19. The forest fire detection system according to claim 16,
characterized in that
the first terminal is arranged in a fixed location.

20. The forest fire detection system according to claim 16,
characterized in that
the first terminal has a sensor for forest fire detection, a communication device, an energy storage and/or an energy conversion device.

21. The forest fire detection system according to claim 16,
characterized in that
the second terminal is movable.

22. The forest fire detection system according to claim 16,
characterized in that
the second terminal has a sensor for forest fire detection, a navigation device, a drive and/or an energy storage.

23. The forest fire detection system according to claim 22,
characterized in that
the sensor of the first terminal is different from the sensor of the second terminal.

24. The forest fire detection system according to claim 16,
characterized in that
the network has a central server.

25. The forest fire detection system according to claim 16,
characterized in that
the network has multiple gateways, wherein the gateways are mesh gateways and/or border gateways.
